(19) United States
(12) Patent Application Publication
(10) Pub. No.: US 2025/0346095 A1
(43) Pub. Date: Nov. 13, 2025

(54) Air Vents for a Vehicle

(71) Applicant: Illinois Tool Works Inc., Glenview, IL (US)

(72) Inventor: Joachim Pestke, Enkenbach-Alsenborn (DE)

(21) Appl. No.: 19/188,903

(22) Filed: Apr. 24, 2025

(30) Foreign Application Priority Data
May 13, 2024 (DE) 10 2024 113 259.0

(51) Int. Cl. B60H 1/34

(52) U.S. Cl. CPC B60H 1/3421

(57) ABSTRACT

The disclosure relates to an air vent (1) for a motor vehicle. The air vent (1) includes a housing (2) and at least one air stream-controlling and/or air stream-deflecting element (7, 8), which is accommodated at least partially or regionally in the housing (2) and is mounted in a movable, and in particular a pivotable, manner relative to the housing (2) in order to deflect as needed, at least at an air outlet of the air vent (1), an air stream flowing through the air duct (6) from a main flow direction (H). The air vent (1) includes a device, which is configured so as to eliminate or at least reduce or weaken a Coandă effect occurring in particular in the case of a deflection of the air stream from the main flow direction (H) at a region of the inner wall of the housing (2) and/or at a wall region of the at least one air stream-controlling and/or air stream-deflecting element (7, 8) and/or at a wall region guiding the air stream inside and/or outside of the housing (2).

### RELATED APPLICATIONS

The present application claims the benefit of German Patent Application No. 10 2024 113 259.0, filed May 13, 2024, titled “Air Discharge System for a Vehicle,” the contents of which are hereby incorporated by reference.

### BACKGROUND

In ventilation apparatuses for vehicles, air vents or air vent nozzles are typically used, which enable the exiting air stream to be controlled in a targeted manner. Such air vents are used in order to supply fresh air in particular into a vehicle interior.

The air stream flows through an inlet opening at an air inlet region of the air vent into the air duct, which is delimited by the housing wall of the air vent, through said air duct, and ultimately through an outlet opening at the air outlet region of the air vent into the interior of a motor vehicle (for example, a car or truck). The air stream generally follows a main flow direction, which can run in particular at least substantially parallel to a longitudinal axis of the housing of the air vent.

In known air vents, the air stream is deflected from the main flow direction by one or more air-guiding elements, for example pivotable air-guiding blades. In addition to the air-guiding elements, the housing of the air vent that delimits the air duct can also serve to deflect the air from the main flow direction.

For example, air vents are known whose housing walls run arcuately or diverge from one another in the direction of one another at least at the air inlet region or at the air outlet region, wherein an air stream directed by an air-guiding element in the direction of the arcuate housing wall follows the arc shape and thus undergoes a corresponding deflection. Such air vents are known, for example, from DE 20 2015 102 026 U1 and DE 10 2017 111 011 A1.

Furthermore, reference is made here to the publication DE 20 2013 012 285 U1. In the air vent known from this prior art, two mutually opposite housing walls of the air vent housing are designed in an arcuate fashion. An air-guiding element having a first air-guiding surface and a second air-guiding surface opposite the first air-guiding surface are arranged in the air vent housing, wherein a first air duct is formed by the housing and the first air-guiding surface, and a second air duct is formed by the housing and the second air-guiding surface. The first air duct is configured in order to transport a first volumetric flow of air that can be passed into the housing through the air inlet opening to the air outlet opening, while the second air duct is configured in order to transport a second volumetric flow of air that can be passed into the housing through the air inlet opening to the air outlet opening.

In addition, in the air vent known from the publication DE 20 2013 012 285 U1, a wing element is arranged in the housing, wherein the wing element is movably arranged in an air inlet section between the air inlet opening and the end of the air-guiding element facing said opening. The movability of the wing element is configured such that the direction of the air exiting the air outlet opening is adjusted due to the position of the wing element.

In particular, the operation of the air vent known from the publication DE 20 2013 012 285 U1 is based on the air deflection being achieved by varying the volumetric flows (first and second volumetric flow) through the two air ducts formed using the air-guiding element. By adjusting or varying the ratio of the volumetric flows flowing through the first and second air ducts of the known air vent, a desired air deflection of the air streaming out of the air outlet region of the air vent is substantially performed.

However, it has been shown that the mechanism for causing air deflection proposed in DE 20 2013 012 285 U1 reduces the performance of the air vent, i.e., the volumetric flow that can be emitted by the air vent per unit of time and/or the “quality” of the volumetric flow that can be emitted by the air vent, in particular with regard to air stream fanning and direction.

Above all, with the approach known from DE 20 2013 012 285 U1, for example, an evenly distributed volumetric flow at the air outlet region of the air vent cannot be achieved for different positions of the air vent.

On the other hand, for design reasons, there is a partial desire to integrate the outlet openings of the air vents harmoniously into the overall I-board design as slot-like openings in such a way that the functional elements of the air vents, in particular the blades, are not directly discernible from the vehicle interior. However, reducing the outlet opening of an air vent goes hand in hand with further problems. In particular, it has been shown that targeted deflection of the air stream is no longer achievable in air vents with slot-shaped outlet openings or is still only partially achievable. This is particularly true when a certain deflection angle is exceeded by the main current direction. Thus, in particular in the case of air vents with a slot-shaped outlet opening, the viable deflection region of the air stream exiting the outlet opening is only reduced to a relatively low deflection region.

Based on the situation described above, the underlying problem of the present disclosure is to further develop an air vent to the effect that an optimized air deflection is ensured even across a relatively large deflection region, wherein the overall performance of the air vent is simultaneously improved. In particular, an air vent with a slot-shaped outlet opening is to be specified, which allows for an optimized quality of the flow rate discharged from the air vent over the entire deflection region of the air stream exiting the outlet opening with regard to the orientation of the air stream.

### SUMMARY

The present disclosure relates generally to air vents, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1 illustrates schematically and in a cross-sectional view, a barrel-type air vent having air deflection according to the prior art, i.e., without a corresponding device for eliminating or reducing/attenuating the Coandă effect.

FIG. 2 illustrates schematically and in a cross-sectional view, a first exemplary embodiment of the air vent according to the disclosure, which, like the air vent shown in FIG. 1, is embodied as a barrel vent, wherein an air conduction shell of the air vent is embodied with an inwardly jumping edge, which serves as an initial start for a wake vortex.

FIG. 3 illustrates schematically and in a cross-sectional view, an air vent embodied as a double-fluted vent, without a device for eliminating or reducing/attenuating the Coandă effect.

FIG. 4 illustrates schematically and in a cross-sectional view, a second exemplary embodiment of the air vent according to the disclosure, which, like the air vent shown in FIG. 3, is embodied as a double-fluted vent and comprises an active device for influencing the boundary layer by blowing on the boundary layer.

FIG. 5 illustrates schematically and in a cross-sectional view, a third exemplary embodiment of the air vent according to the disclosure, which is embodied as a single-fluted vent and comprises an active device for influencing the boundary layer by blowing on the boundary layer in order to eliminate the Coandă effect.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y, and/or z” means “one or more of x, y, and z.”

The present disclosure relates to an air vent for a vehicle, and in particular an air vent for a ventilation system of a motor vehicle. Furthermore, the disclosure relates to a ventilation system having such an air vent. Accordingly, the disclosure relates in particular to an air vent for a motor vehicle, wherein the air vent comprises a housing having an air inlet region and an air outlet region, wherein an air duct is formed at least partially or regionally through the housing.

The air vent according to the disclosure further comprises at least one air stream-controlling and/or air stream-deflecting element, which is accommodated at least partially or regionally in the housing and is mounted in a movable, and in particular a pivotable, manner relative to the housing in order to deflect as needed, at least at an air outlet of the air vent, an air stream flowing through the air duct from a main flow direction.

The walls of the housing can be straight; however, arcuate wall regions of the housing are advantageous, in particular at the air outlet region of the housing of the air vent.

In order to ensure an optimized air deflection and a continuous change of the air deflection, namely over the entire deflection region of the air vent, it is provided according to the disclosure that the air vent comprises a device, which is configured so as to eliminate or at least reduce or weaken a Coandă effect occurring in particular in the case of a deflection of the air stream from the main flow direction at a region of the inner wall of the housing and/or at a wall region of the at least one air stream-controlling and/or air stream-deflecting element and/or at a wall region guiding the air stream inside and/or outside of the housing.

The disclosure is based on the recognition that the disadvantage described above finds its cause in the so-called “Coandă effect” in conventional air vents in particular with regard to the reduced deflection region of the air stream.

The Coandă effect refers to interrelated phenomena that suggest a tendency of a gas jet to “slide along” on a convex surface rather than dislodge and continue in the original direction of flow. In air or gas flows, the Coandă effect occurs in particular in the case of spatially narrow flows, as is the case at least regionally inside an air vent.

If a surface delimiting the air duct, in particular the housing of the air vent and/or the at least one air stream-controlling and/or air stream-deflecting element, retreats from the original flow direction, i.e., in particular from the main flow direction, the air stream does not flow straight ahead but instead follows the surface.

Such a surface, which retreats from the main flow direction, occurs in particular when, for the purposes of air stream deflection, the at least one air stream-controlling and/or air stream-deflecting element is pivoted or deflected out of its neutral position. Due to the then-forming Coandă effect or the then-forming Coandă flow at least in the region of the surface which retreats from the main flow direction and/or in a region downstream therefrom, only a bad or completely impossible, targeted (controlled) deflection of the air stream is still possible with regard to the quality.

Often, the Coandă effect acts up to a particular deflection position to then act all at once upon exceeding the critical deflection angle of flow dislodgement from the Coandă wall. The region of the desired deflection under the influence of Coandă is thus not always/analogously continuously controllable.

In order to achieve a continuous air deflection in the entire deflection or control region, it is proposed according to the disclosure to implement an air deflection that is independent of the Coandă effect.

According to the present disclosure, this is achieved by the device for eliminating or reducing/attenuating the Coandă effect. The mechanism for eliminating or reducing/attenuating the Coandă effect works such that by removing the vacuum between the flowing air jet and the Coandă wall, the Coandă effect is dissolved.

In particular, in the realizations of the air vent according to the disclosure, it is provided that the device is effective for eliminating or reducing/attenuating the Coandă effect in a region of the inner wall of the housing and/or in a wall region of the at least one air stream-controlling and/or air stream-deflecting element and/or in a wall region guiding the air stream within and/or outside of the housing, wherein said region at least partially or regionally retreats from a main flow direction of air stream prevailing in said region.

In particular, this is a wall region which is convex with regard to the main flow direction of the air stream prevailing in this region.

Various solutions that can be combined as desired can be considered for the implementation of the device for eliminating or reducing the Coandă effect.

For example, according to embodiments of the air vent according to the disclosure, it is provided that the device for elimination or reduction/weakening of the Coandă effect is configured so as to form a flow stall and/or a separation swirl only when the air vent is perfused with an air stream deflection at least partially and/or regionally at the region of the inner wall of the housing and/or at the wall region of the at least one air stream-controlling and/or air stream- deflecting element and/or at the wall region guiding the air stream inside and/or outside the housing.

In other words, the device for eliminating or reducing/attenuating the Coandă effect is in particular configured to deliberately induce a boundary layer separation in the corresponding region of the air vent.

The boundary layer separation is a flow-mechanical effect that causes a flow to not follow the contour of a body or surface around which the flow occurs. Downstream of the separation point, between the laminar main flow and the body or wall contour, a swirled region forms, which is also sometimes referred to as dead water or overrun.

A boundary layer separation is caused by a counter-rotating pressure increase. This is the case, for example, when the corresponding wall region of the air vent, in which the boundary layer separation and thus the flow breakage are to be induced, provides an edge or step projecting into the main flow.

In particular, to eliminate the Coandă effect in the air stream around the at least one air stream-controlling and/or air stream-deflecting element movable and in particular pivotably mounted relative to the housing, it is preferred that the device for eliminating or reducing/attenuating the Coandă effect is configured so as to, only in the event that the air stream filter is perfused with air stream deflection, and in particular with a minimum deflection of the air stream, form a corresponding flow break-off and/or a separating bubble/separating swirl on the region of the inner wall of the housing and/or on the wall region of the at least one air stream-controlling and/or air stream-deflecting element and/or on the wall region of the air stream conducting wall region within and/or outside of the housing.

In particular, the device for elimination or reduction of the Coandă effect should be configured so as to generate a flow stall with a separation bubble/separation swirl downstream of the separation region when the housing is perfused in particular with an air stream deflection in such a manner that there is no re-striking of the stream at the region of the inner wall of the housing and/or at the wall region of the at least one air stream-controlling and/or air stream-deflecting element and/or at the wall region guiding the air stream inside and/or outside the housing downstream of the separation region.

According to realizations of the air vent according to the disclosure, it is provided that, for forming a flow stall and/or a separation bubble/separation swirl in a region of the inner wall of the housing and/or in a wall region of the at least one air stream-controlling and/or air stream-deflecting element and/or in a wall region guiding the air stream inside and/or outside the housing, at which the air stream would at least partially or regionally strike without the device for elimination or reduction/weakening of the Coandă effect, and/or the contour of which the air stream would at least partially or regionally follow without the device for elimination or reduction/weakening of the Coandă effect, an edge, in particular an edge of an inwardly jumping region, is formed.

In other words, according to the present disclosure, a boundary layer separation is deliberately provoked, and thus a flow breakage is provoked, as a result of which a turbulent flow region arises downstream of the separation point, so that the air stream cannot follow the contour of the wall region.

In some ways, this measure represents overcoming a prejudice of the professional world, because laminar air stream is usually strived for in the design and layout of an air vent. However, by inducing an interface separation regionally, the Coandă effect can surprisingly be turned off, as a result of the deflection region for the air stream being independent from the Coandă effect, and in particular over the entire deflection region, an optimal, continuously controllable air stream deflection is achieved with consistent quality.

According to further developments of the last mentioned design variant, in which the device for eliminating or reducing/attenuating the Coandă effect is formed by an edge, in particular by an edge of an inwardly jumping region, it is provided that the edge is formed in a region in which, due to a narrowing of the effective flow cross-section, at least locally an increased flow rate of the air stream occurs.

This measure is based on the recognition that in the region where there is at least locally an increased flow rate of the air stream due to a constriction of the effective flow region, static pressure has a minimum, which simplifies a boundary layer separation.

Alternatively or in addition to the design variant, in which the device for eliminating or reducing the Coandă effect is formed by an edge, in particular by an edge of an inwardly jumping region, it is contemplated that the device for eliminating or reducing/attenuating the Coandă effect is designed at least partially as an active device for boundary layer influence.

One possibility for such an active device for boundary layer influence is to induce the boundary layer on the region of the inner region of the inner wall of the housing and/or on the wall region of the at least one air stream-controlling and/or air stream-deflecting element and/or on the air stream conducting wall region within and/or outside of the housing. In particular, air is blown onto the boundary layer on at least one surface of the air vent restricting the air duct.

According to realizations of the device for boundary layer influence, it is provided that the active device for boundary layer interference comprises at least one preferably slot-shaped intake/exhaust opening, which serves, in particular as needed or continuously, to introduce additional air into the air stream that is flowing past the region of the inner wall of the housing and/or into the air stream that is flowing past the wall region of the at least one air stream-controlling and/or air stream-deflecting element, and/or into the air stream that is flowing past the wall region guiding the air stream inside and/or outside the housing.

Particularly preferably, it is provided that the active device for boundary layer interference is configured so as to introduce additional air, in particular as needed, into the air stream via the preferably slot-shaped intake/exhaust opening in accordance with the Venturi principle.

The air vent according to the disclosure can be embodied as a single-fluted or multi-fluted air vent.

In this context, in particular, it is conceivable that the air vent comprises an air stream splitter that is accommodated at least regionally in the housing of the air vent such that, at least regionally or sectionally, an air duct delimited or defined by the housing is divided into a first air duct and into a second air duct separated therefrom.

For the as-needed separation of the total air stream flowing through the air duct delimited or defined by the housing per unit of time into a first air stream portion flowing through the first air duct and a second air stream portion flowing through the second air duct, the air vent comprises an in particular valve-like air stream control element, which, starting from a neutral position in which the air stream control element is at least partially and/or regionally and preferably completely aligned with the air stream splitter when viewed in the main flow direction of the air stream flowing through the air vent, is pivotable relative to the air stream splitter so that an air supply to the first or second air duct is at least partially or regionally blocked.

In such a design of the air vent according to the disclosure as a single-fluted or multi-fluted air vent, it is conceivable in particular that, in the air outlet region of the housing, two mutually opposed housing walls converge with one another at least regionally, and wherein, at least in a converging wall region of the housing, at least one active device for boundary layer interference with at least one preferably slot-shaped intake/exhaust opening is provided, which serves in particular to introduce additional air into the air stream passing through the air duct, in particular as needed or continuously.

Alternatively or additionally, it is conceivable that, when viewed in the main flow direction, an edge region with an edge that is partially or regionally jumping into the air stream is formed upstream of the at least one preferably slot-shaped intake/exhaust opening, and in particular immediately adjacent to the at least one preferably slot-shaped intake/exhaust opening.

However, the present disclosure is not limited to single or multi-fluid air vents. Rather, it is also suggested to use the device for eliminating or reducing/attenuating the Coandă effect on an air vent embodied as a “barrel” vent and, for as-needed air deflection in a first direction, in particular in a vertical direction, has at least two air conduction shells that are at least regionally mutually opposed to each other and can be pivoted about a common axis of rotation that is perpendicular to the first direction relative to the housing, between which an air duct is formed.

The at least two air conduction shells are in particular mounted in a uniformly pivotable manner together and preferably relative to one another. A surface bounding the air duct between the two air conduction shells, preferably of each air conduction shell, is designed so as to be in particular convexly curved or angular towards the air duct.

In this design variant, the occurrence of a Coandă effect on the wall region of the air conduction shells should be eliminated. It is conceivable, for example, that in a wall region of at least one air conduction shell, an inwardly jumping step is arranged.

In short, the disclosure is based on the recognition that, by providing the device for eliminating or reducing/attenuating the Coandă effect, the Coandă effect is broken up by a lifting of the negative pressure between a flowing air jet and the corresponding Coandă wall.

This is achieved in particular by the following two measures:
1. introducing a flow stall edge as an initial start for a wake vortex; and/or
2. supplying additional air to the start region of the wake vortex by vacuum suction (Venturi principle), so that the Coandă-based negative pressure on the Coandă wall is lifted, which causes the flow to adhere to the Coandă wall.

With these measures, the air stream can be continuously deflected or controlled independently, so that, overall, with the air vent, a continuous air deflection in the whole deflection or adjustment range of the air vent is feasible independently of the Coandă effect.

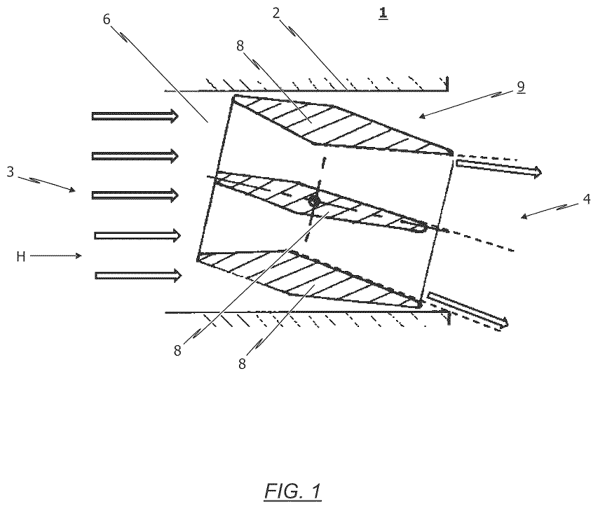

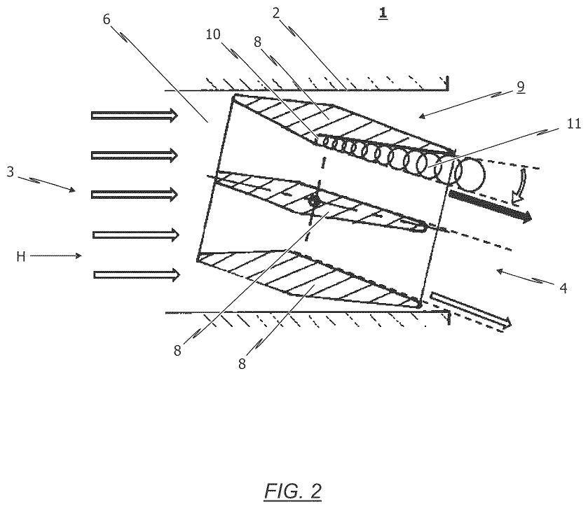

In FIG. 1 and FIG. 2, air vents 1 configured as barrel vents are shown schematically and in a sectional view.

The air vent 1 configured as a barrel vent comprises a housing 2 having an inlet opening at an air inlet region 3 and an outlet opening at an air outlet region 4, wherein the air outlet opening of the air vent 1 is delimited by a housing outlet wall 5. An air duct 6 for an air stream passing through the housing 2 along a main flow direction H is defined between the inlet opening and the outlet opening. The air vent 1 is installed in a vehicle, such as a car or truck, and in particular directs fresh air into the interior of the vehicle.

A total of three air stream-deflecting elements 8 are arranged in the housing 2 in the barrel vents shown in FIG. 1 and FIG. 2. In the exemplary embodiment shown, the air stream-deflecting elements 8 have a prism-shaped cross-sectional geometry, although other cross-sectional geometries are contemplated.

In particular, the air stream-deflecting elements 8 should have a shape in which the air duct 6 is preferably narrowed in a central region between two adjacent air stream-deflecting elements 8.

The air stream-deflecting elements 8 serve to optionally deflect air in a first direction, for example in a vertical direction, and are pivotable about a common axis of rotation that is perpendicular to the first direction relative to the housing 2, wherein an air duct is formed between the respectively adjacent air deflecting elements. The air stream-deflecting elements 8 together form the so-called “barrel” 9.

In particular, the air stream-deflecting elements 8 are arranged in the housing 2 in an adjustable manner between a first and a second end position. The air stream-deflecting elements 8 can also occupy intermediate positions between the end positions, if necessary.

The air stream-deflecting elements 8 can be identical in configuration and can be arranged in a merely mirrored manner to one another, as is the case with the barrel vents shown in FIG. 1 and FIG. 2.

In particular, the air stream-deflecting elements 8 can be moveable in the same way, again in particular only mirrored with respect to one another.

The air stream conducting elements 8 can be cup-shaped, for example they can be cylinder shells. However, other curvature geometries are also conceivable, for example a tapered or parabolic curvature. The curvature geometry can in particular depend on the opening geometry of the air vent 1. For example, tapered curvatures can be employed in the case of a tapered opening gap. Generally speaking, the air stream-deflecting elements 8 can have a continuously curved shape.

Convex side walls of the air stream-deflecting elements 8 can face each other.

The air stream-deflecting elements 8 must be made with increased deformation slopes due to shrinkage onto the core in the injection molding tool. These increased deformation slopes inside the barrel 9 formed by the air stream-deflecting elements 8 aerodynamically cause the air stream, as indicated in FIG. 1 with the arrows shown therein, through the conical cross-section opened in the flow direction.

In particular, it is indicated in FIG. 1 that, in the barrel outflow known from the prior art, due to the embodiments of the air stream-deflecting elements 8 of the barrel 9, an expanded air stream is generated at the air outlet region 4 of the air vent, which is not desired.

In order to prevent the widening of the air stream exiting the air vent 1, as indicated in FIG. 2, a step 10 at the closest point of the flow duct within the barrel 9 is introduced in at least one air stream-deflecting element 8, and as a result a local flow breakage is caused with subsequent wake vortex formation. The region in the flow duct filled in by the subsequent wake vortex 11 causes a reduction of the vent effect within the barrel 9. The reduced vent effect more effectively influences the air stream when deflecting the air stream.

The solution shown in FIG. 2 thus provides for a deflection-enhanced effect on a diffusely acting barrel 9. A flow duct of the barrel 9 is partially closed by the wake vortex formation.

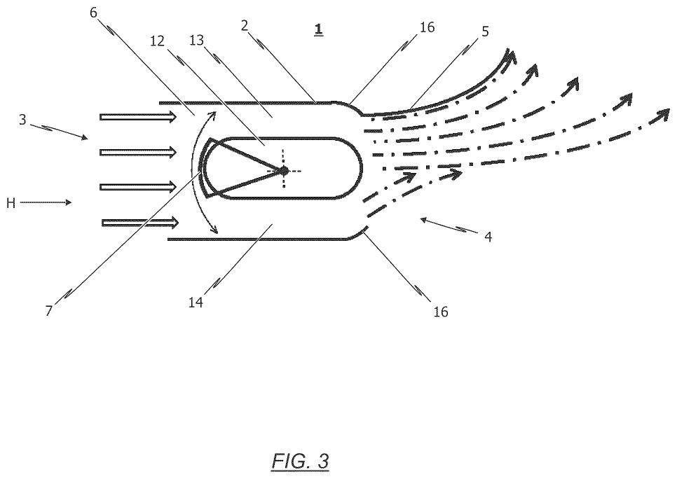

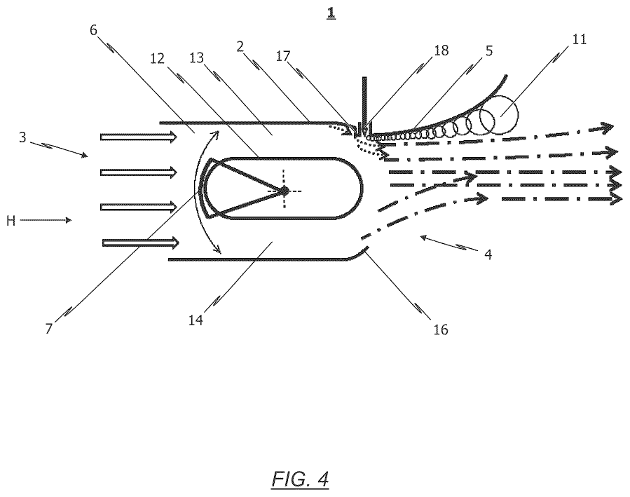

A second exemplary embodiment of the air vent 1 is described in further detail in the following with reference to the drawings in FIG. 3 and FIG. 4.

The air vent 1 is designed as a double-fluted air vent or as a double-duct air vent.

The air vent 1 comprises an at least substantially straight housing 2 having an air inlet region 3 and an opposite air outlet region 4. In this context, the term “at least substantially straight” means that the opposite side walls of the housing 2 of the air vent 1 run at least substantially parallel to one another.

It can also be seen that, in both the double-duct air vent according to FIG. 3 and the double-duct air vent according to FIG. 4, respectively, an air stream splitter 12 is received in the housing 2 of the air vent 1, so that at least regionally or partially, an air duct 6 that is limited or defined by the housing 2 is divided into a first air duct 13 and into a second air duct 14 that is separated therefrom.

For the as-needed separation of the total air stream flowing through the air duct 6 delimited or defined by the housing 2 per unit of time into a first air stream portion flowing through the first air duct 13 and a second air stream portion flowing through the second air duct 14, the air vent 1 comprises an air stream control element 7, which, starting from a neutral position shown in FIG. 3 and FIG. 4, in which the air stream control element 7 is at least partially and/or regionally and preferably completely aligned with the air stream splitter 12 when viewed in the main flow direction H of the air stream flowing through the air vent 1, is pivotable relative to the air stream splitter 12 so that an air supply to the first air duct 13 or second air duct 14 is at least partially or regionally blocked.

A nozzle aperture 16 is formed in the air outlet region 4. Two opposite wall regions are designed so as to at least partially converge with one another. These wall regions form a so-called Coandă wall in the air vent 1 shown in FIG. 3, because a flow adherence to the nozzle aperture 16 caused by the Coandă effect can be observed there.

Such flow adhesion to the nozzle aperture 16 can always be observed regardless of the number of vent flutes.

Specifically, FIG. 3 illustrates how the air stream is deflected upwardly by the Coandă effect on the nozzle aperture 16/Coandă wall despite setting the air stream-controlling element 7 in the neutral position.

If, for example, the air stream-controlling element 7 is now moved downwards from the neutral position in order to prevent this, the air stream separates from the nozzle aperture 16/Coandă wall only after a certain point. This separation occurs abruptly, so that a continuous controllability of the air stream from the neutral setting up to this control position is not possible.

To circumvent this, the air vent 1 shown in FIG. 4 schematically and in a sectional view has an active device for influencing the boundary layer by blowing air on the boundary layer on an inner wall region of the housing 2.

In addition, an edge 17 is used, which is embodied as a flow stall edge and functions as an initial start for a wake vortex 11. At the flow breakage edge, the flow dislodges from the wall and continues to flow as shown by the arrows. A wake vortex 11 starts behind the stall edge.

By supplying/suctioning additional air through openings or slots 18 in the wall in the start region of the wake vortex 11 directly behind the flow stall edge, the existing vacuum on the Coandă wall is dissolved via vacuum suction, which previously caused the flow to be adhered to the Coandă wall. Thus, the air stream can then be continuously deflected or controlled independently of Coandă.

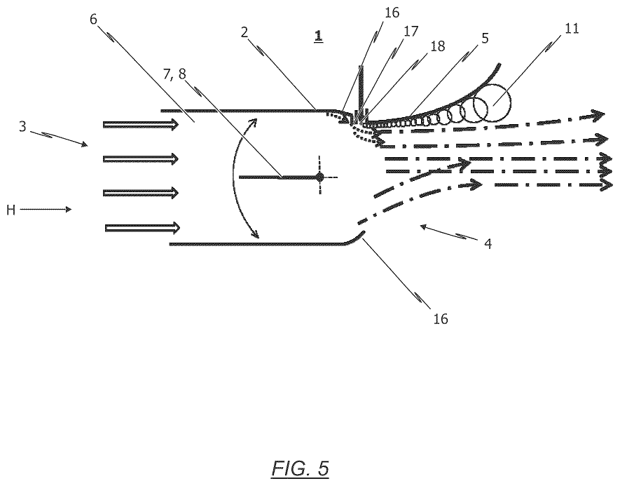

FIG. 5 schematically and in a sectional view shows a third exemplary embodiment of the air vent 1 according to the disclosure, which is embodied as a single-fluted vent and has an active means for influencing the boundary layer by blowing air on the boundary layer to eliminate the Coandă effect.

While the present method and/or system have been described with reference to certain implementations, it will be understood by those skilled in the art that various changes may be made, and equivalents may be substituted without departing from the scope of the present method and/or system. In addition, many modifications may be made to adapt a particular situation or material to the teachings of the present disclosure without departing from its scope. For example, block and/or components of examples disclosed may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

### LIST OF REFERENCE NUMERALS

1 Air vent
2 Housing
3 Air inlet region
4 Air outlet region
5 Housing outlet wall
6 Air duct
7 Air stream-controlling element
8 Air stream-deflecting element
9 Barrel
10 Step
11 Wake vortex/separation bubble/separation swirl
12 Air stream splitter
13 First air duct
14 Second air duct
16 Nozzle aperture
17 Edge
18 Opening/slot/suction/exhaust opening
H Main flow direction

What is claimed is:

1. An air vent (1) for a motor vehicle comprising:
a housing (2) having an air inlet region (3) and an air outlet region (4), wherein an air duct (6) is formed at least partially or regionally by the housing (2); and
at least one air stream-controlling and/or air stream-deflecting element (7, 8), which is accommodated at least partially or regionally in the housing (2) and is mounted in a movable manner relative to the housing (2) in order to deflect as needed, at least at an air outlet of the air vent (1), an air stream flowing through the air duct (6) from a main flow direction (H),
wherein the air vent (1) comprises a device, which is configured so as to eliminate or at least reduce or weaken a Coandă effect occurring in a case of a deflection of the air stream from the main flow direction (H) at a region of an inner wall of the housing (2) and/or at a wall region of the at least one air stream-controlling and/or air stream-deflecting element (7, 8) and/or at a wall region guiding the air stream inside and/or outside of the housing (2).

2. The air vent (1) according to claim 1,
wherein the region of the inner wall of the housing (2) and/or the wall region of the at least one air stream-controlling and/or air stream-deflecting element (7, 8) and/or the wall region guiding the air stream inside and/or outside of the housing (2) retreats at least partially or regionally away from a main flow direction (H) of the air stream prevailing in this region.

3. The air vent (1) according to claim 1,
wherein the region of the inner wall of the housing (2) and/or the wall region of the at least one air stream-controlling and/or air stream-deflecting element (7, 8) and/or the wall region guiding the air stream inside and/or outside of the housing (2) is configured convexly, at least partially or regionally, in relation to a main flow direction (H) of the air stream prevailing in this region.

4. The air vent (1) according to claim 1,
wherein the device for elimination or reduction/weakening of the Coandă effect is configured so as to form a flow stall and/or a separation swirl (11) when the air vent (1) is perfused with an air stream deflection at least partially and/or regionally at the region of the inner wall of the housing (2) and/or at the wall region of the at least one air stream-controlling and/or air stream-deflecting element (7, 8) and/or at the wall region guiding the air stream inside and/or outside the housing (2).

5. The air vent (1) according to claim 1,
wherein the device for elimination or reduction/weakening of the Coandă effect is configured so as to form a flow stall and/or a separation swirl (11) only when the air vent (1) is perfused with an air stream deflection at least partially and/or regionally at the region of the inner wall of the housing (2) and/or at the wall region of the at least one air stream-controlling and/or air stream-deflecting element (7, 8) and/or at the wall region guiding the air stream inside and/or outside the housing (2).

6. The air vent (1) according to claim 4,
wherein the device for elimination or reduction of the Coandă effect is configured so as to generate a flow stall with a separation swirl (11) downstream of a separation region when the housing (2) is perfused with an air stream deflection in such a manner that there is no re-striking of the stream at the region of the inner wall of the housing (2) and/or at the wall region of the at least one air stream-controlling and/or air stream-deflecting element (7, 8) and/or at the wall region guiding the air stream inside and/or outside the housing (2) downstream of the separation region.

7. The air vent (1) according to claim 4,
wherein, for forming a flow stall and/or a separation swirl (11) in a region of the inner wall of the housing (2) and/or in a wall region of the at least one air stream-controlling and/or air stream-deflecting element (7, 8) and/or in a wall region guiding the air stream inside and/or outside the housing (2), at which the air stream would at least partially or regionally strike without the device for elimination or reduction/weakening of the Coandă effect, and/or a contour of which the air stream would at least partially or regionally follow without the device for elimination or reduction/weakening of the Coandă effect, an edge (10, 17) is formed.

8. The air vent (1) according to claim 7,
wherein the edge (10, 17) is formed in a region in which there is an at least locally increased flow rate of the air stream due to a narrowing of an effective flow cross-section.

9. The air vent (1) according to claim 1,
wherein the device for elimination or reduction/weakening of the Coandă effect is configured at least partially as an active device for boundary layer interference by blowing on the boundary layer at the region of the inner wall of the housing (2) and/or at the wall region of the at least one air stream-controlling and/or air stream-deflecting element (7, 8) and/or at the wall region guiding the air stream inside and/or outside the housing (2).

10. The air vent (1) according to claim 9,
wherein the active device for boundary layer interference comprises at least one preferably slit-shaped intake and/or exhaust opening (18), which serves to cause a negative pressure-induced air induction, and thus to introduce additional air into the air stream that is flowing past the region of the inner wall of the housing (2) and/or into the air stream that is flowing past the wall region of the at least one air stream-controlling and/or air stream- deflecting element (7), 8) and/or into the air stream that is flowing past the wall region guiding the air stream inside and/or outside the housing (2).

11. The air vent (1) according to claim 9,
wherein the active device for boundary layer interference is configured so as to introduce additional air into the air stream via the preferably slot-shaped intake and/or exhaust opening (18) in accordance with the Venturi principle.

12. The air vent (1) according to claim 1, wherein the air vent (1) comprises the following:
an air stream splitter (12) accommodated at least regionally in the housing (2) such that, at least regionally or sectionally, an air duct (6) delimited or defined by the housing (2) is split into a first air duct (13) and a second air duct (14) separated therefrom,
wherein, for as-needed separation of the total air stream flowing through the air duct (6) delimited or defined by the housing (2) per unit of time into a first air stream portion flowing through the first air duct (13) and a second air stream portion flowing through the second air duct (14), the air vent (1) comprises a valve-like air stream control element (7), which, starting from a neutral position in which the air stream control element (7) is at least partially and/or regionally and preferably completely aligned with the air stream splitter (12) when viewed in the main flow direction (H) of the air stream flowing through the air vent (1), is pivotable relative to the air stream splitter (12) so that an air supply to the first or second air duct (13, 14) is at least partially or regionally blocked.

13. The air vent (1) according to claim 12,
wherein, in the air outlet region (4) of the housing (2), two mutually opposed housing walls converge with one another at least regionally, and
wherein, at least in a converging wall region of the housing (2), at least one active device for boundary layer interference with at least one preferably slit-shaped intake and/or exhaust opening (18) is provided, which serves to introduce additional air into the air stream passing through the air duct (6).

14. The air vent (1) according to claim 13,
wherein, when viewed in the main flow direction (H), an edge region with an edge (10, 17) jumping into the air stream is formed upstream of the at least one preferably slit- shaped intake and/or exhaust opening (18), and immediately adjacent to the at least one preferably slit-shaped intake and/or exhaust opening (18).

15. The air vent (1) according to claim 1,
wherein, for the as-needed air deflection in a first direction in a vertical direction, the air outlet (1) comprises at least two air conduction shells that are mutually opposed to one another at least regionally and can be pivoted about a common axis of rotation that is perpendicular to the first direction relative to the housing (2), between which two shells an air duct is formed,
wherein the at least two air conduction shells are in commonly and preferably uniformly pivotable relative to one another, and
wherein a surface of each air conduction shell delimiting the air duct (6) between the at least two air conduction shells is configured so as to be in particular convexly curved or angular in the direction of the air duct.
